(19) United States
(12) Patent Application Publication
(10) Pub. No.: US 2005/0147002 A1
(43) Pub. Date: Jul. 7, 2005

(54) Optical recording medium, apparatus for recording/recording data on/from optical recording medium, method of recording/recording data on/from optical recording medium, and computer-readable recording medium on which program enabling the method is recorded

(75) Inventors: Sung-hee Hwang, Seoul (KR); Juno-wan Ko, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/024,788

(22) Filed: Dec. 30, 2004

(30) Foreign Application Priority Data
Jan. 5, 2004 (KR) 2004-368
Feb. 18, 2004 (KR) 2004-13785

(51) Int. Cl. G11B 5/09

(52) U.S. Cl. 369/47.14; 369/53.15

(57) ABSTRACT

An optical recording medium, an apparatus for recording/reproducing data on/from the optical recording medium, a method of recording/reproducing data on/from the optical recording medium, and a computer-recordable recording medium, on which a program for executing the method is recorded, are provided. A lead-in area, a user data area, and a lead-out area are arranged on the optical recording medium. The user data area includes a defect list (DL) area, in which a DL, including information on defects that have occurred in the user data area, is recorded, and the lead-in area or the lead-out area includes a disc definition structure (DDS)/recording management data (RMD) area, in which a DDS, used for managing the optical recording medium, and RMD, used for managing a recording state of the optical recording medium, are recorded. Accordingly, it is possible to efficiently manage the storage capacity of a disc by effectively performing defect management on the disc.

### CROSS-REFERENCE TO RELATED APPLICATIONS

This application claims the benefit of Korean Patent Application Nos. 2004-00368 and 2004-13785, filed on Jan. 5, 2004 and Feb. 28, 2004, respectively, in the Korean Intellectual Property Office, the disclosures of which are incorporated herein in their entirety by reference.

### BACKGROUND OF THE INVENTION

1. Field of the Invention

The present invention relates to a disc, and more particularly, to an optical recording medium, an apparatus for recording/reproducing data on/from an optical recording medium, a method of recording/reproducing data on/from an optical recording medium, and a computer-readable recording medium storing a program for executing the method.

2. Description of the Related Art

Defect management is a process for compensating for data loss caused by a defect in a user data area of a disc, i.e., a defective block, by rewriting user data recorded in the defective block to a new portion of the user data area. Generally, conventional defect management is performed using a linear replacement method or a slipping replacement method. In the linear replacement method, a defective portion of a user data area is replaced with a non-defective portion of a spare area. In the slipping replacement method, a defective portion is slipped, and a next non-defective portion is used.

In the linear replacement method, a block of a user data area in which a defect occurs is called a defective block. A spare area composed of blocks, which are used as substitutes for the defective blocks, is provided in a predetermined area of the disc. Whereas a lead-in area, a middle area, and a lead-out area are arranged on a disc according to manufacturer specifications when manufacturing the disc, determining whether to allot the spare area on the disc is performed when initializing the disc before use.

Accordingly, it is necessary to efficiently manage the storage capacity of a disc, especially, a write-once disc, from/on which data cannot be erased/overwritten.

### SUMMARY OF THE INVENTION

The present invention provides an optical disc, an apparatus for recording/reproducing data on/from an optical disc, a method of recording/reproducing data on/from an optical disc, by which the storage capacity of an optical disc can be efficiently managed by effectively performing defect management, and a computer-readable recording medium storing a program for executing the method.

Additional aspects and/or advantages of the invention will be set forth in part in the description which follows and, in part, will be obvious from the description, or may be learned by practice of the invention.

According to an aspect of the present invention, there is provided an optical recording medium including a single recording layer, on which a lead-in area, a user data area, and a lead-out area are arranged. Here, the user data area includes a defect list (DL) area, in which a DL, including information on defects that have occurred in the user data area, is recorded, and the lead-in area or the lead-out area includes a disc definition structure (DDS)/recording management data (RMD) area, in which a DDS, used for managing the optical recording medium, and RMD, used for managing a recording state of the optical recording medium, are recorded.

According to another aspect of the present invention, there is provided an optical recording medium including double recording layers, on which a lead-in area, a user data area, a middle area, and a lead-out area are arranged. Here, the user data area includes a defect list (DL) area, in which a DL, including information on defects that have occurred in the user data area, is recorded, and the lead-in area, the lead-out area, or the middle area includes a DDS/RMD area, in which a DDS, used for managing the optical recording medium, and RMD, used for managing a recording state of the optical recording medium, are recorded.

According to another aspect of the present invention, there is provided an optical recording medium, on which a lead-in area, a user data area, and a lead-out area are arranged. The user data area includes an SA/DL zone, in which replacement blocks respectively replacing blocks in the user data area where defects have occurred are arranged, and a DL containing information on the defects in the user data area, is recorded.

In an aspect of the present invention, portions of the SA/DL zone where each of the replacement blocks is respectively arranged is determined when there is a need to arrange each of the replacement blocks in the SA/DI zone, rather than in advance.

In an aspect of the present invention, portions of the SA/DL zone where the DL is recorded is determined when there is a need to record the DL in the SA/DI zone, rather than in advance.

In an aspect of the present invention, a beginning or ending portion of the user data area is defined as the SA/DL zone.

In an aspect of the present invention, the lead-in area or the lead-out area includes a DDS/RMD area, in which a DDS/RMD block is recorded, and the DDS/RMD block includes a DDS, used for managing the optical recording medium, and RMD, used for managing a recording state of the optical recording medium.

In an aspect of the present invention, the DDS includes location information of a next recordable portion of the SA/DL zone.

In an aspect of the present invention, the DDS/RMD block is updated according to the recording state of the optical recording medium, and updated DDS/RMD blocks are sequentially recorded in the DDS/RMD area.

In an aspect of the present invention, a first DDS recorded in the DDS/RMD area includes location information of the SA/DL zone in the user data area and location information of the DDS/RMD area in the lead-in area or lead-out area.

According to another aspect of the present invention, there is provided an apparatus for recording/reproducing data on/from an optical recording medium. The apparatus includes: a reading/writing unit, which writes data on or reads data from a single-layered recording medium, on which a lead-in area, a user data area, and a lead-out area are arranged; and a control unit, which controls the reading/writing unit to write a DL, containing information on defects that have occurred in the user data area, in a DL zone arranged in the user data area, and to write a DDS, used for managing the single-layered recording medium, and RMD, used for managing a recording state of the single-layered recording medium, in a DDS/RMD area arranged in the lead-in area or in the lead-out area.

According to another aspect of the present invention, there is provided an apparatus for recording/reproducing data on/from an optical recording medium. The apparatus includes: a reading/writing unit, which writes data on or reads data from a double-layered recording medium, on which a lead-in area, a user data area, a middle area, and a lead-out area are arranged; and a control unit, which controls the reading/writing unit to write a DL, containing information on defects that have occurred in the user data area, in a DL zone arranged in the user data area, and to write a DDS, used for managing the double-layered recording medium, and RMD, used for managing a recording state of the double-layered recording medium, in a DDS/RMD area arranged in the lead-in area, in the middle area or in the lead-out area.

According to another aspect of the present invention, there is provided an apparatus for recording/reproducing data on/from an optical recording medium. The apparatus includes: a reading/writing unit, which writes data on or reads data from an optical recording medium, on which a lead-in area, a user data area, a middle area, and a lead-out area are arranged; and a control unit, which controls the reading/writing unit to write replacement blocks respectively replacing blocks in the user data area where defects have occurred in an SA/DL zone arranged in the user data area and records a DL, containing information on the defects in the user data area, in the SA/DL zone.

In an aspect of the present invention, the control unit controls the reading/writing unit to sequentially write the replacement blocks in recordable portions of the SA/DL zone.

In an aspect of the present invention, the control unit controls the reading/writing unit to write the DL in a recordable portion of the SA/DL zone.

In an aspect of the present invention, control unit allocates the SA/DL zone at a beginning or ending portion of the user data area as the SA/DL zone.

In an aspect of the present invention, the control unit controls the reading/writing unit to write a DDS/RMD block, which includes a DDS used for managing the optical recording medium and RMD used for managing a recording state of the optical recording medium in a DDS/RMD area arranged in the lead-in area or lead-out area.

In an aspect of the present invention, the control unit also controls the reading/writing unit to write the DDS, containing location information of a next recordable portion of the SA/DL zone, in the DDS/RMD area.

In an aspect of the present invention, the control unit also controls the reading/writing unit to write an updated DDS/RMD block in the DDS/RMD area.

In an aspect of the present invention, the control unit controls the reading/writing unit to record a DDS/RMD block, which includes a DDS, used for managing the optical recording medium, and RMD, used for managing a recording state of the optical recording medium, in a beginning portion of the DDS/RMD area.

According to another aspect of the present invention, there is provided a method of recording data on an optical recording medium on which a lead-in area, a user data area, and a lead-out area are arranged. The method includes: recording a DL, which contains information on defects that have occurred in the user data area, in a DL zone arranged in the user data area; and recording a DDS, which is used for managing the single-layered recording medium, and RMD, which is used for managing a recording state of the single-layered recording medium, in a DDS/RMD area arranged in the lead-in area or lead-out area.

According to another aspect of the present invention, there is provided a method of recording/reproducing data on/from an optical recording medium on which a lead-in area, a user data area, a middle area, and a lead-out area are arranged. The method includes: recording a DL, containing information on defects that have occurred in the user data area, in a DL zone arranged in the user data area; and recording a DDS, used for managing the double-layered recording medium, and RMD, used for managing a recording state of the double-layered recording medium, in a DDS/RMD area arranged in the lead-in area, middle area, or lead-out area.

According to another aspect of the present invention, there is provided a method of recording data on an optical recording medium, on which a lead-in area, a user data area, a middle area, and a lead-out area are arranged. The method includes defining replacement blocks in an SA/DL zone arranged in the user data area and recording a DL, which contains information on defects that have occurred in the user data area, in the SA/DL zone, the replacement blocks respectively replacing blocks in the user data area where the defects have occurred.

In an aspect of the present invention, in the defining of the replacement blocks in the SA/DL zone, the replacement blocks are sequentially arranged in recordable portions of the SA/DL zone.

In an aspect of the present invention, in the recording of the DL, the DL is recorded in a recordable portion of the SA/DL zone.

In an aspect of the present invention, the method of recording data on an optical recording medium also includes allocating the SA/DL zone at a beginning or ending portion of the user data area.

In an aspect of the present invention, the method of recording data on an optical recording medium also includes recording a DDS/RMD block, which includes a DDS used for managing the optical recording medium and RMD used for managing a recording state of the optical recording medium, in a DDS/RMD area arranged in the lead-in area or lead-out area.

In an aspect of the present invention, the method of recording data on an optical recording medium also includes forming the DDS to include location information of a next recordable portion of the SA/DL zone.

In an aspect of the present invention, the method of recording data on an optical recording medium also includes recording an updated DDS/RMD block in the DDS/RMD area are sequentially recorded in the DDS/RMD area.

In an aspect of the present invention, the method of recording data on an optical recording medium also includes recording a DDS/RMD block, which includes a DDS used for managing the optical recording medium and RMD used for managing a recording state of the optical recording medium in a beginning portion of the DDS/RMD area.

According to another aspect of the present invention, there is provided a method of reproducing data from an optical recording medium on which a lead-in area, a user data area, and a lead-out area are arranged. The method includes: reading a DL, which contains information on defects that have occurred in a user data area of a single-layered recording optical recording medium, from a DL zone arranged in the user data area; and reading a DDS, which is used for managing the single-layered recording optical recording medium, and RMD, which is used for managing a recording state of the single-layered recording optical recording medium, from a DDS/RMD area arranged in the lead-in area or lead-out area.

According to another aspect of the present invention, there is provided a method of reproducing data from an optical recording medium on which a lead-in area, a user data area, a middle area, and a lead-out area are arranged. The method includes: reading a DL, which contains information on defects that have occurred in a user data area of a double-layered recording optical recording medium, from a DL zone arranged in the user data area; and reading a DDS, which is used for managing the single-layered recording optical recording medium, and RMD, which is used for managing a recording state of the single-layered recording optical recording medium, from a DDS/RMD area arranged in the lead-in area, middle area, or lead-out area.

According to another aspect of the present invention, there is provided a method of reproducing data from an optical recording medium, on which a lead-in area, a user data area, a lead-out area are arranged. The method includes reading data from replacement blocks in an SA/DL zone on the optical recording medium and reading a DL, which contains information on defects that have occurred in the user data area, from the SA/DI zone, the replacement blocks respectively replacing blocks in the user data area where the defects have occurred.

In an aspect of the present invention, the method of reproducing data from an optical recording medium includes reading a DDS/RMD block, which includes a DDS used for managing the optical recording medium and RMD used for managing a recording state of the optical recording medium, from a DDS/RMD area arranged in the lead-in area or lead-out area.

In an aspect of the present invention, the method of reproducing data from an optical recording medium also includes obtaining location information of a next recordable portion of the SA/DL zone from the DDS.

In an aspect of the present invention, the method of reproducing data from an optical recording medium also includes reading most recently updated DDS/RMD from a last DDS/RMD block of a plurality of DDS/RMD blocks in the DDS/RMD area, the DDS/RMD being updated whenever the recording state of the optical recording medium changes.

In an aspect of the present invention, the method reproducing data from an optical recording medium also includes reading location information of the SA/DL zone in the user data area and location information of the DDS/RMD area in the lead-in area or lead-out area from a first DDS/RMD block of the plurality of DDS/RMD blocks in the DDS/RMD area.

According to another aspect of the present invention, there is provided a computer-readable recording medium on which a program for executing a method of recording data on an optical recording medium, on which a lead-in area, a user data area, and a lead-out area are arranged, is recorded. The method includes: recording a DL, which contains information on defects that have occurred in the user data area, in a DL zone arranged in the user data area; and recording a DDS, which is used for managing the single-layered recording medium, and RMD, which is used for managing a recording state of the single-layered recording medium, in a DDS/RMD area arranged in the lead-in area or lead-out area.

According to another aspect of the present invention, there is provided a computer-readable recording medium on which a program for executing a method of reproducing data from an optical recording medium, on which a lead-in area, a user data area, a lead-out area are arranged, is recorded, is recorded. The method includes: reading a DL, which contains information on defects that have occurred in a user data area of a single-layered recording optical recording medium, from a DL zone arranged in the user data area; and reading a DDS, which is used for managing the single-layered recording optical recording medium, and RMD, which is used for managing a recording state of the single-layered recording optical recording medium, from a DDS/RMD area arranged in the lead-in area or lead-out area.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an apparatus for recording/reproducing data on/from an optical recording medium, according to an embodiment of the present invention;

FIG. 2A is a diagram illustrating the structure of a single-layered recording disc according to an embodiment of the present invention;

FIG. 2B is a diagram illustrating the structure of a single-layered recording disc according to another embodiment of the present invention;

FIG. 3A is a diagram illustrating the structure of a double-layered recording opposite track path (OTP) disc according to an embodiment of the present invention;

FIG. 3B is a diagram illustrating the structure of a double-layered recording parallel track path (PTP) disc according to an embodiment of the present invention;

FIG. 3C is a diagram illustrating the structure of a double-layered recording OTP disc according to another embodiment of the present invention;

FIG. 3D is a diagram illustrating the structure of a double-layered recording PTP disc according to another embodiment of the present invention;

FIG. 4 is a diagram illustrating the structure of a spare area/defect list (SA/DL) zone according to an embodiment of the present invention;

FIG. 5 is a diagram illustrating the structure of DL #i of FIG. 4;

FIG. 6 is a diagram illustrating the structure of ‘information on defect #i’ of FIG. 4;

FIG. 7 is a diagram illustrating a process of recording defect management information on defects that have occurred in a user data area on a disc in an SA/DL zone according to an embodiment of the present invention;

FIG. 8 is a diagram illustrating the structure of a disc definition structure/recording management data (DDS/RMD) zone according to an embodiment of the present invention;

FIG. 9 is a diagram illustrating the structure of DDS/RMD zone #0 of FIG. 8;

FIG. 10 is a diagram illustrating the structure of DDS #i of DDS/RMD ZONE #i of FIG. 8;

FIG. 11 is a diagram illustrating the structure of RMD #i of DDS/RMD ZONE #i of FIG. 8; and

FIG. 12 is a flowchart of a disc management method for recording/reproducing data on/from an optical disc, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

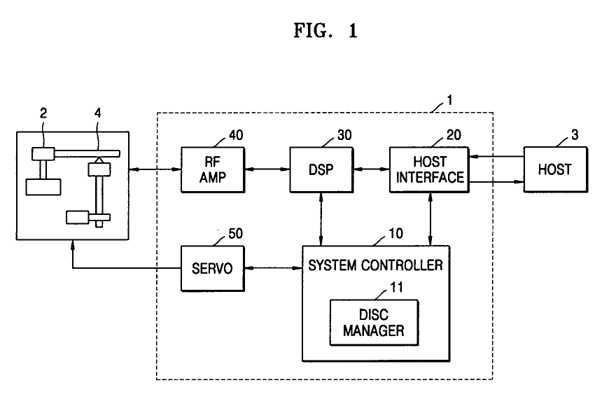

FIG. 1 is a block diagram of an apparatus for recording/reproducing data on/from an optical recording medium, according to an exemplary embodiment of the present invention. Referring to FIG. 1, the apparatus includes a writing/reading unit 2 and a control unit 1.

The writing/reading unit 2 includes a pickup and writes data on or reads data from a disc 4, which is an example of an optical recording medium according to the present invention.

The control unit 1 controls the writing/reading unit 2 to write data on or read data from the disc 4 by following a predetermined file system. In the present embodiment, the control unit 1 adopts a verify-after-write method, in which it is determined whether there are defective portions on the disc 4 data by recording data on the disc 4 on a predetermined data unit basis and then verifying the recorded data. In each recording operation, the control unit 1 writes data on the disc 4 and determines which portions on the disc 4 are defective. Thereafter, the control unit 1 generates defect information indicating which portions on the disc 4 are defective, stores the defect information in a memory (not shown), and records a portion of the defect information stored in the memory on the disc 4 as temporary defect information.

A recording operation is a unit operation determined based on a user's intent and which type of data recording the user desires to perform and ranges from the moment when the disc 4 is loaded in the apparatus to the moment when the disc 4 is unloaded from the apparatus after recording data on the disc 4. In each recording operation, a process of verifying the data written on the disc 4 is performed at least one time, and typically, more than two times. The temporary defect information, obtained as a result of performing the verify-after-write method, is temporarily stored in the memory.

When a user hits an ‘eject’ button on the apparatus after completing the recording of data on the disc 4 and then removes the disc 4 from the apparatus, the control unit 1 recognizes that a current recording operation has ended. Then, the control unit 1 reads the temporary defect information from the memory, provides the temporary defect information to the writing/reading unit 2, and commands the writing/reading unit 2 to record the temporary defect information on the disc 4.

The control unit 1 includes a system controller 10, a host interface 20, a digital signal processor (DSP) 30, a radio frequency (RF) amplifier 40, and a servo 50.

When recording data on the disc 4, the host interface 20 receives a write command from a host 3 and transmits the write command to the system controller 10. The system controller 10 controls the digital signal processor 30 and the servo 50 in order to execute the write command received from the host interface 20. The digital signal processor 30 adds additional data, such as parity data, to data to be recorded, received from the host interface 20, generates error correction code (ECC) blocks by ECC encoding the addition results, and modulates the ECC blocks in a predetermined manner. The RF amplifier 40 converts data output from the digital signal processor 30 into an RF signal. The writing/reading unit 2 records the RF signal received from the RF amplifier 40 on the disc 4. The servo 50 receives a command required for servo control from the system controller 10 and servo-controls the pickup of the writing/reading unit 2.

The system controller 10 further includes a disc manager 11 for efficiently managing the disc 4 and effectively performing defect management.

In a case where the disc 4 is a single-layered recording optical disc where a lead-in area, a user data area, and a lead-out area are sequentially arranged, the disc manager 11 controls the writing/reading unit 2 to write a defect list (DL), containing information on defects that have occurred in the user data area, in a DL zone in the user data area and to write a disc definition structure (DDS) and recording management data (RMD) in a DDS/RMD zone in the lead-in or lead-out area. Here, the DDS is used for managing the disc 4, and the RMD is used for managing the state of data recorded on the disc 4.

In a case where the disc 4 is a double-layered recording optical disc where a lead-in area, a user data area, a middle area, and a lead-out area are sequentially arranged, the disc manager 11 controls the writing/reading unit 2 to write a DL, containing information on defects that have occurred in the user data area, in a DL zone in the user data area and can record a DDS and RMD in a DDS/RMD zone in any one or some combination of the lead-in, middle, or lead-out area.

Alternatively, in a case where a lead-in area, a user data area, and a lead-out area are sequentially arranged on the disc 4, the disc manager 11 may control the writing/reading unit 2 to write data in replacement blocks, which are located in a spare area (SA)/defect list (DL) zone in the user data area and respectively replace defective blocks in the user data area, and can record a DL in the SA/DL zone. Specifically, the disc manager 11 controls the writing/reading unit 2 to sequentially write data in replacement blocks, which are located in a recordable portion of the SA/DL zone, and then to write the DL in another recordable portion of the SA/DL zone.

Alternatively, in a case where the lead-in area, the user data area, and the lead-out area are sequentially arranged on the disc 4, the disc manager 11 controls the writing/reading unit 2 to write DDS/RMD blocks in a DDS/RMD zone in the lead-in or lead-out area on the disc 4. Specifically, the disc manager 11 controls the writing/reading unit 2 to write location information of the SA/DL zone in the user data area and location information of the DDS/RMD zone in the lead-in or lead-out area in a beginning portion of the DDS/RMD zone as a first DDS/RMD block and then to update predetermined information in the rest of the DDS/RMD zone as DDS/RMD blocks subsequent to the first DDS/RMD block. The predetermined information is updated whenever a data recording state of the disc 4 changes and includes location information of a portion of the SA/DL zone, in which a next portion of the predetermined information can be recorded.

The disc manager 11 allocates an area for the SA/DL zone at the beginning or ending portion of the user data area as the SA/DL zone.

When reproducing data from the disc 4, the host interface 20 receives a read command from the host 3. The system controller 10 performs an initialization process required for reproducing data from the disc 4. The writing/reading unit 2 applies a laser beam to a surface of the disc 4, obtains an optical signal by receiving a laser beam reflected from the surface of the disc 4, and outputs the optical signal. The RF amplifier 40 converts the optical signal output from the writing/reading unit 2 into an RF signal, obtains modulated data and a servo signal from the RF signal, and provides the modulated data and the servo signal to the digital signal processor 30 and the servo 50, respectively. Here, the servo signal is used for controlling the servo 50. The digital signal processor 30 demodulates the modulated data received from the RF amplifier 40, thereby obtaining ECC data. The servo 50 receives the servo signal from the RF amplifier 40 and receives a command required for servo control from the system controller 10. Then, the servo 50 performs servo control on the pickup of the writing/reading unit 2 using the servo signal and the command. The host interface 20 receives the ECC data from the digital signal processor 30 and then transmits the ECC data to the host 3. The system controller 10 controls the servo 50 to read disc management information or disc defect information from the disc 4 and to read data from non-defective portions of the disc 4 based on the disc management information or disc defect information.

In a case where the disc 4 is a single-layered recording optical disc where a lead-in area, a user data area, and a lead-out area are sequentially arranged, the disc manager 11 controls the writing/reading unit 2 to read a DL, containing information on defects that have occurred in the user data area, from a DL zone in the user data area and to read a DDS and RMD from a DDS/RMD zone in the lead-in or lead-out area.

In a case where the disc is a double-layered recording optical disc where a lead-in area, a user data area, a middle area, and a lead-out area are sequentially arranged, the disc manager 11 controls the writing/reading unit 2 to read a DL, containing information on defects that have occurred in the user data area, from a DL zone in the user data area and can read a DDS and RMD from a DDS/RMD zone in the lead-in, middle, or lead-out area.

Alternatively, in a case where a lead-in area, a user data area, and a lead-out area are sequentially arranged on the disc 4, the disc manager 11 controls the writing/reading unit 2 to read data from replacement blocks, which are located in an SA/DL zone in the user data area and respectively replace defective blocks in the user data area, and to read a DL, containing information on defects that have occurred in the user data area, from the SA/DL zone.

Alternatively, in a case where the lead-in area, the user data area, and the lead-out area are sequentially arranged on the disc 4, the disc manager 11 controls the writing/reading unit 2 to read location information of the SA/DL zone in the user data area and location information of a DDS/RMD zone in the lead-in or lead-out area from a first DDS/RMD block recorded in the DDS/RMD zone.

The apparatus of FIG. 1 may be divided into an apparatus for recording data on an optical recording medium and an apparatus for reproducing data from an optical recording medium, or may be realized as a single device, into which the recording and reproducing apparatuses are integrated.

The structure of an optical recording medium according to an exemplary embodiment of the present invention will now be described in further detail.

Disc management information (DMI), which is recorded on the optical recording medium according to the exemplary embodiment of the present invention, is composed of a DDS, RMD, and a DL. A disc management area (DMA), in which the DMI is recorded, includes a temporary disc management area (TDMA), in which temporary DMI is recorded, and a finalized disc management area (FDMA), in which finalized DMI is recorded.

A TDMA includes a DDS/RMD zone, in which a DDS and RMD are recorded, and a DL zone, in which a DL is recorded.

A DDS includes location information of a TDMA or location information of DMI. Specifically, a DDS includes location information of an SA/DL zone, in which replacement blocks are located and a DL is recorded, location information of a DDS/RMD zone, location information of the DL in the SA/DL zone, location information of each recordable portion of the SA/DL zone, in which an updated DL or replacement blocks can be stored, a consistency flag, which is used for determining whether a disc has been normally ejected from the apparatus during a previous recording operation, and record protection information, which is used for preventing data from being recorded on the disc.

RMD, which is used for managing data recorded on a disc, includes R-zone entries, which specify the states of the respective R-zones in a sequential recording mode, and a bitmap, which is a map of bit values respectively indicating whether data is recorded in the corresponding respective recording blocks of a user data area.

A DDS/RMD zone, in which the DDS and the RMD are recorded, is provided in a lead-in and/or lead-out area of a single-layered recording disc or in any one or some combination of a lead-in, middle, or lead-out area of a double-layered recording disc. At the stage of initializing a disc before using the disc, a drive manufacturer or a user may define part of a user data area of the disc as the DDS/RMD zone, thereby increasing the number of times each DDS/RMD block can be updated.

A DL includes location information of defective blocks, which are detected during recording/reproducing data on/from a disc, and location information of replacement blocks, which respectively replace the defective blocks. A DL zone, in which the DL is recorded, is not a fixed zone. Rather, the DL zone is arranged in an SA/DL zone in a user data area of the disc whenever a request to update the DL is issued. Conventionally, a spare area is provided at a predetermined portion of a disc, wherein replacement blocks are located and location information is stored in a lead-in or lead-out area. In the SA/DL zone, replacement blocks are located, and the DL, which comprises disc defect information, i.e., location information of defective blocks of a disc and location information of replacement blocks, is recorded.

A disc is finalized when no recording space is left on the disc so that new data cannot be recorded on the disc or when a user does not want to record new data on the disc any longer or wants to use the disc only for data reproduction purposes. Disc management information on the finalized disc is stored in an FDMA on the finalized disc.

A power calibration area (PCA) is provided on the disc for determining which one of a plurality of recording powers that have been used when recording data on the disc is an optimal recording power and determining variables associated with a write strategy that has been used when recording the data on the disc.

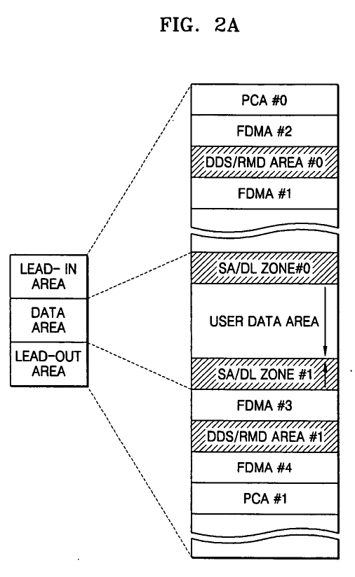

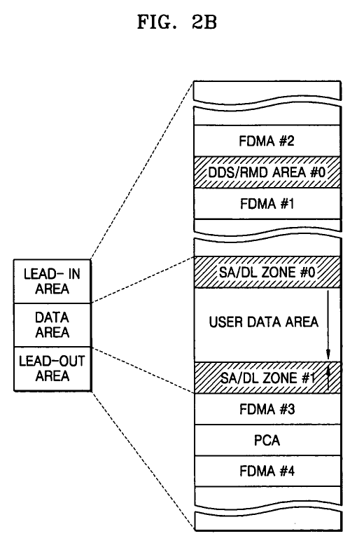

FIG. 2A is a diagram illustrating the structure of a single-layered recording disc according to an exemplary embodiment of the present invention. Referring to FIG. 2A, a lead-out area is formed along the outer circumference of the single-layered recording disc, a lead-in area is formed along the inner circumference of the single-layered recording disc, and a data area is interposed between the lead-out area and the lead-in area.

The lead-in area includes PCA #0, FDMA #1, FDMA #2, and DDS/RMD area #0, the data area includes a user data area, SA/DL zone #0, and SA/DL zone #1, and the lead-out area includes PCA #1, FDMA #3, FDMA #4, and DDS/RMD area #1.

FIG. 2B is a diagram illustrating the structure of a single-layered recording disc according to another exemplary embodiment of the present invention. Referring to FIG. 2B, a lead-out area is formed along the outer circumference of the single-layered recording disc, a lead-in area is formed along the inner circumference of the single-layered recording disc, and a data area is interposed between the lead-out area and the lead-in area.

The lead-in area includes FDMA #1, FDMA #2, and DDS/RMD area #0, the data area includes a user data area, SA/DL zone #0, and SA/DL zone #1, and the lead-out area includes a PCA, FDMA #3, and FDMA #4.

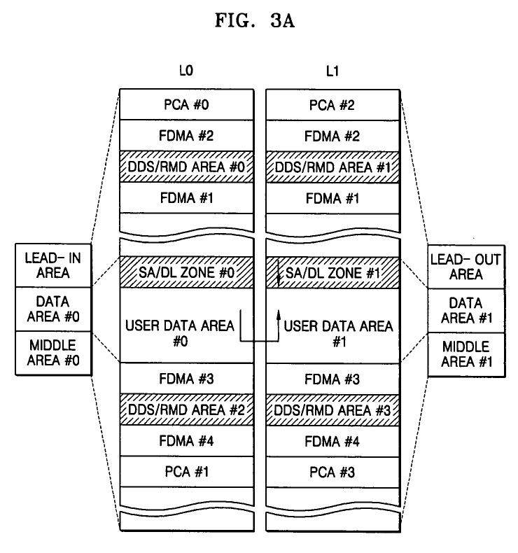

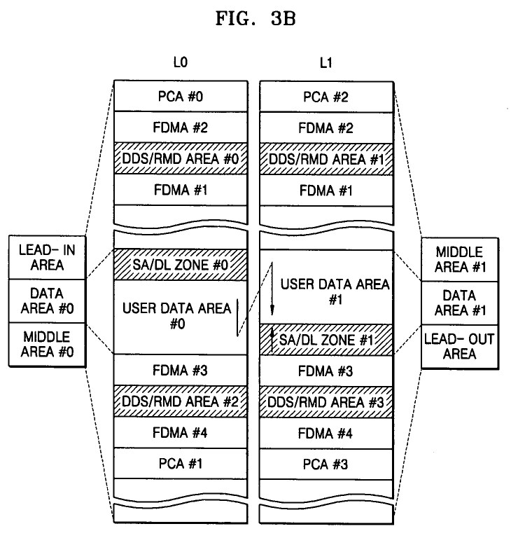

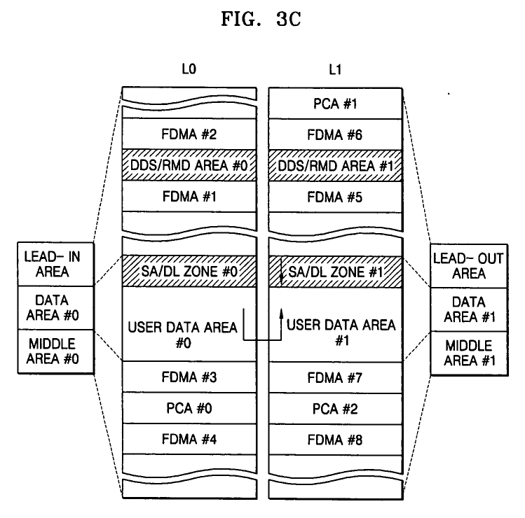

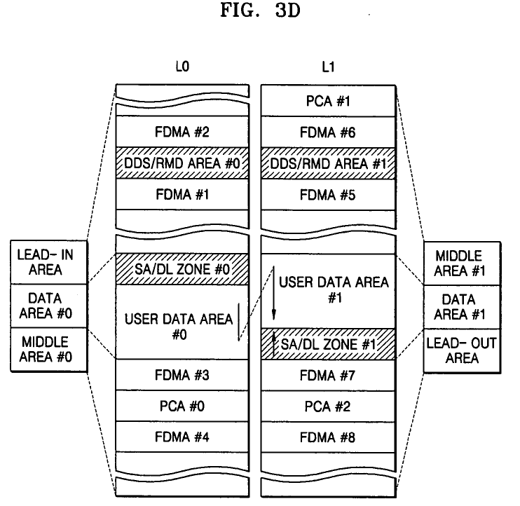

FIG. 3A is a diagram illustrating the structure of a double-layered recording opposite track path (OTP) disc according to an exemplary embodiment of the present invention. Referring to FIG. 3A, the double-layered recording OTP disc includes two recording layers L0 and L1. A lead-in area, data area #0, and middle area #0 are sequentially arranged on the recording layer L0. Middle area #1, data area #1, and a lead-out area are sequentially arranged on the recording layer L1.

The lead-in area includes PCA #0, FDMA #2, DDS/RMD area #0, and FDMA #1. Data area #0 includes SA/DL zone #0 and user data area #0. Middle area #0 includes FDMA #3, DDS/RMD area #2, FDMA #4, and PCA #1. Middle area #1 includes FDMA #3, DDS/RMD area #3, FDMA #4, and PCA #3. Data area #1 includes SA/DL zone #1 and user data area #1. The lead-out area includes PCA #2, FDMA #2, DDS/RMD area #1, and FDMA #1.

FIG. 3B is a diagram illustrating the structure of a double-layered recording parallel track path (PTP) disc according to an exemplary embodiment of the present invention. Referring to FIG. 3B, the double-layered recording PTP disc includes two recording layers L0 and L1. A lead-in area, data area #0, and middle area #0 are sequentially arranged on the recording layer L0. Middle area #1, data area #1, and a lead-out area are sequentially arranged on the recording layer L1.

The lead-in area includes PCA#0, FDMA#2, DDS/RMD area #0, and FDMA#1. Data area #0 includes SA/DL zone #0 and user data area #0. Middle area #0 includes FDMA #3, DDS/RMD area #2, FDMA #4, and PCA #1. The lead-out area includes FDMA #3, DDS/RMD area #3, FDMA #4, and PCA #3. Data area #1 includes SA/DL zone #1 and user data area #1. Middle area #1 includes PCA #2, FDMA #2, DDS/RMD area #1, and FDMA #1.

FIG. 3C is a diagram illustrating the structure of a double-layered recording OTP disc according to another exemplary embodiment of the present invention. Referring to FIG. 3C, the double-layered recording OTP disc includes two recording layers L0 and L1. A lead-in area, data area #0, and middle area #0 are sequentially arranged on the recording layer L0. Middle area #1, data area #1, and a lead-out area are sequentially arranged on the recording layer L1.

The lead-in area includes FDMA #2, DDS/RMD area #0, and FDMA #1. Data area #0 includes SA/DL zone #0 and user data area #0. Middle area #0 includes FDMA #3, PCA #0, and FDMA #4. Middle area #1 includes FDMA #7, PCA #2, and FDMA #8. Data area #1 includes SA/DL zone #1 and user data area #1. The lead-out area includes PCA #1, FDMA #6, DDS/RMD area #1, and FDMA #5.

FIG. 3D is a diagram illustrating the structure of a double-layered recording PTP disc according to another exemplary embodiment of the present invention. Referring to FIG. 3D, the double-layered recording PTP disc includes two recording layers L0 and L1. A lead-in area, data area #0, middle area #0 are sequentially arranged on the recording layer L0. Middle area #1, data area #1, and a lead-out area are sequentially arranged on the recording layer L1.

The lead-in area includes FDMA #2, DDS/RMD area #0, and FDMA #1. Data area #0 includes SA/DL zone #0 and user data area #0. Middle area #0 includes FDMA #3, PCA #0, and FDMA #4. Middle area #1 includes PCA #1, FDMA #6, DDS/RMD area #1, and FDMA #5. Data area #1 includes SA/DL zone #1 and user data area #1. The lead-out area includes FDMA #7, PCA #2, and FDMA #8.

A temporary disc management area (i.e., an SA/DL zone) provided on the disc of each of FIGS. 2A through 3D will now be described in greater detail.

Referring to FIGS. 2A through 3D, an SA/DL zone is provided on a disc as part of a user data area, regardless of whether the disc is a single-layered recording disc or a double-layered recording disc.

As described above, the SA/DL zone includes replacement blocks, which respectively replace defective blocks in the user data area, and stores disc defect information, which comprises location information of the defective blocks in the user data area and location information of the replacement blocks. When there is a need to replace a defective block with a replacement block due to a defect occurring in a user data area, location information of the defective block and location information of the replacement block should be recorded somewhere in the user data area so that a disc drive can search for the replacement block and can fetch data from the searched replacement block, rather than from the defective block, when a host issues a command to read data from the defective block.

Since replacement blocks are closely related to a DL, the DL is preferably, but not necessarily, updated whenever a replacement block is newly assigned to each defective block in the user data area. Therefore, the replacement blocks and the DL are located in the same zone, rather than in different areas. Specifically, the replacement blocks are provided in a recordable portion of a predetermined area, and then the DL is recorded in another recordable portion of the predetermined area. Accordingly, a head or optical pickup does not need to move back and forth between two different areas providing the replacement blocks in one of the areas and recording the DL in the other area. Therefore, it is possible to reduce the time required for a seek operation and to efficiently use the storage capacity of a disc.

When manufacturing a disc, predetermined portions of the disc are defined as a lead-in area, a middle area, and a lead-out area according to predetermined manufacture standards. However, an SA/DL zone is arranged on the disc when initializing the disc because it is hard to determine how much of an area on the disc is required for replacement blocks and a DL until use of the disc. Therefore, in order to prepare an area on the disc for the replacement blocks and the DL, SA/DL zone #0 is arranged on the disc according to the predetermined manufacture standards at the stage of manufacturing the disc, and, if necessary, SA/DL zone #1 may be arranged in an end portion of a user data area on the disc at the stage of initializing the disc according to a disc manufacturer or user's intent. When defining SA/DL zone #1 on the disc, a direction in which data is recorded in SA/DL zone #1 is preferably, but not necessarily, set to be opposite to a direction in which data is recorded in a user data area on the disc, thereby maximizing the amount of storage area of the user data area in the data recording direction of the user data area. Accordingly, it is possible to efficiently use the storage capacity of the disc.

A DDS/RMD zone is provided in a lead-in area and/or lead-out area on a single-layered recording disc or in any one or some combination of a lead-in, middle, or lead-out area on a double-layered recording disc.

As described above, a DDS includes location information of a TDMA or location information of DMI, and RMD may be R-zone state information in a sequential recording mode, in which data are sequentially recorded in a user data area, or may be data recording state information indicating whether data is recorded on each of a plurality of recording blocks in the user data area in a random recording mode, in which data are arbitrarily recorded in the user data area.

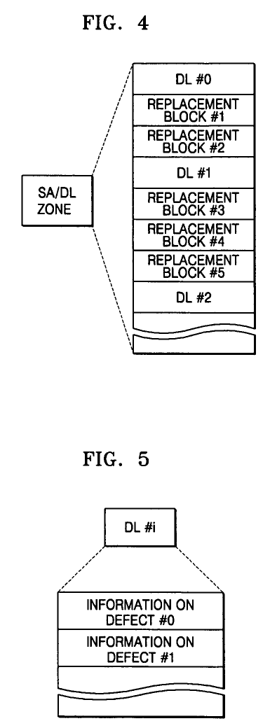

FIG. 4 is a diagram illustrating the structure of an SA/DL zone according to an exemplary embodiment of the present invention. Referring to FIG. 4, the SA/DL zone includes DL #0, replacement block #1, replacement block #2, DL#1, replacement block #3, replacement block #4, replacement block #5, and DL #2.

DL #0 may include initialization information. In recording operation #0, defects #1 and #2 occur. Then, replacement blocks #1 and #2, which respectively replace defective blocks #1 and #2, respectively corresponding to defects #1 and #2, are arranged in a recordable portion of the SA/DL zone next to a recordable portion of the SA/DL zone occupied by DL #0. Thereafter, DL #1, including information on defects #1 and #2, is recorded in a recordable portion of the SA/DL zone next to the recordable portion occupied by replacement blocks #1 and #2. In recording operation #1, defects #3, #4, and #5 occur. Then, replacement blocks #3, #4, and #5, which respectively replace defective blocks #3, #4, and #5, respectively corresponding to defects #3, #4, and #5, are arranged in a recordable portion of the SA/DL zone next to the recordable portion occupied by DL #1. Thereafter, DL #2, including information on defects #3, #4, and #5, is recorded in a recordable portion of the SA/DL zone next to the recordable portion occupied by replacement blocks #3, #4, and #5.

As described above, when defects occur, replacement blocks are arranged in one recordable portion of the SA/DL zone, and then a DL, including information on the defects, is recorded in another recordable portion of the SA/DL zone.

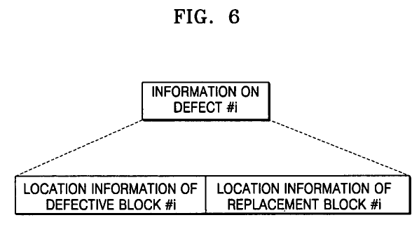

FIG. 5 is a diagram illustrating the structure of DL #i of FIG. 4 where i is a whole number. Referring to FIG. 5, DL #i includes information on at least one defect, e.g., information on defects #0 and #1. Information on one defect corresponds to information on one defective block and one replacement block replacing the defective block. Information on defect #i is illustrated in FIG. 6.

FIG. 6 is a diagram illustrating the information on defect #i where i is a whole number. Referring to FIG. 6, the information on defect #i includes location information of defective block #i and location information of replacement block #i. For example, the location information of defective block #i may be a sector serial number of defective block #i, and the location information of replacement block #i may also be a sector serial number of replacement block #i. The information on defect #i may further include predetermined state information (not shown).

FIG. 7 is a diagram illustrating a process of recording information on defects that have occurred in a user data area on a disc and are managed using an SA/DL zone according to an exemplary embodiment of the present invention. Data can be processed on a sector-by-sector basis or on a cluster-by-cluster basis. A sector is a minimal unit area that can be managed by a file system or an application program of a computer, and a cluster is a minimal unit area, on which data can be recorded on a disc at one time. In general, one or more sectors constitute one cluster.

A sector is divided into a physical sector or a logical sector. A physical sector is a space in which data is recorded. An address called physical sector number (PSN) is allotted to each physical sector. A logical sector is a unit, based on which a file system or application program of a computer manages data, and an address called logical sector number (LSN) is allotted to each logical sector. An apparatus searches for an area on a disc where data is to be recorded by referencing the PSN of the data. The file system or application program manages data recorded on the disc on a logic sector-by-logic sector basis and also manages the location of the data by referencing the LSN of the data.

Referring to FIG. 7, a plurality of physical sectors (not shown), to which PSNs are respectively allotted, exist in a user data area and in the SA/DL zone. LSNs are respectively allotted to consecutive groups of the physical sectors, each comprising at least one physical sector. The LSNs are not allotted to defective sectors in the user data area. Thus, even though a physical sector has the same size as a logical sector, a PSN may not be identical to a corresponding LSN once defects occur on a disc.

Referring to FIG. 7, reference numerals \mathring{1} through \mathring{7} denote unit areas in each of which data is written and then verified. An apparatus for recording/reproducing data on/from an optical recording medium records user data in the area \mathring{1} and then returns to the beginning of the area \mathring{1} to verify whether the user data has been successfully recorded in the area \mathring{1} or whether a defect has occurred in the area \mathring{1}. If the apparatus detects defect #1 in the area \mathring{1}, it defines a portion of the area (D where defect #1 has occurred as defective block #1 and records a part of the user data that has been recorded in defective block #1 in a portion of the SA/DL zone. The portion of the SA/DL zone, which replaces defective block #1 by storing the part of the user data that has been recorded in defective block #1, is arranged as replacement block #1. Thereafter, the apparatus records user data in the area \mathring{2} and then returns to the beginning of the area \mathring{2} to verify whether the user data has been successfully recorded in the area \mathring{2} or whether a defect has occurred in the area (D. If the apparatus detects defect #2 in the area \mathring{2}, it defines a portion of the area (D where defect #2 has occurred as defective block #2 and records a part of the user data that has been recorded in defective block #2 in a portion of the SA/DL zone. The portion of the SA/DL zone, which replaces defective block #2 by storing the part of the user data that has been recorded in defective block #2, is arranged as replacement block #2. Likewise, a portion of the area \mathring{3} where defect #3 occurs is arranged as defective block #3, and a portion of the SA/DL zone where user data that has been recorded in defective block #3 is recorded is arranged as replacement block #3. Since no defect occurs in the area \mathring{4}, no portion of the area® is defined as a defective block.

If recording operation #0, in which the user data is recorded and then verified in each of the areas \mathring{1} through \mathring{4}, is expected to end soon (e.g., if a user hits an ‘eject’ button or all of the user data allotted for recording operation #0 has been recorded), the apparatus records DL #1 including information on defects #1, #2, and #3, in the SA/DL zone.

When recording operation #1 begins, user data is recorded in each of the areas \mathring{5} through \mathring{7}, defects #4 and #5 are detected in the areas \mathring{5} and \mathring{6}, respectively, portions of the SA/DL zone are defined as replacement blocks #4 and #5 for respectively replacing portions of the areas \mathring{5} and \mathring{6} where defects #4 and #5 are detected. Thereafter, if recording operation #1 is expected to end soon, DL #2, containing information on defects #4 and #5, is recorded in the SA/DL zone.

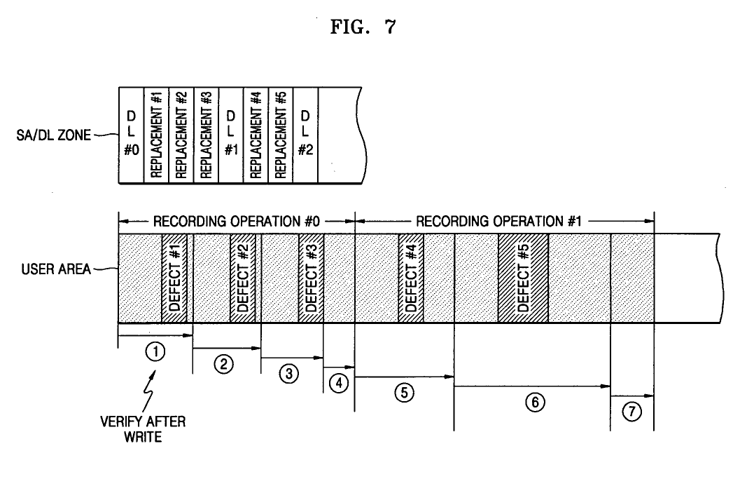

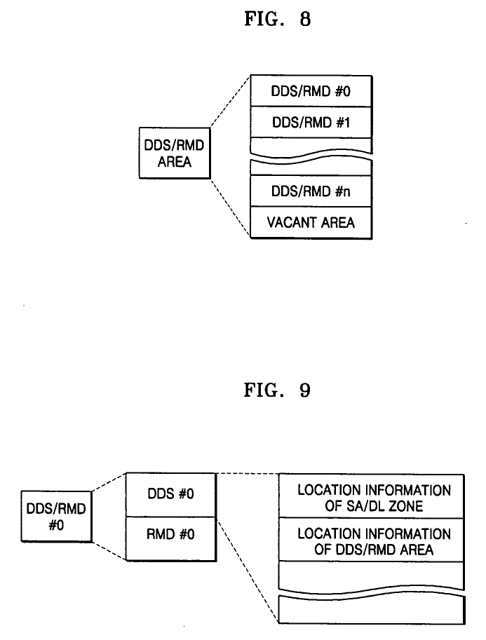

FIG. 8 is a diagram illustrating the structure of a DDS/RMD area according to an exemplary embodiment of the present invention. Referring to FIG. 8, the DDS/RMD area includes DDS/RMD #0, DDS/RMD #1, . . . , and DDS/RMD #n.

DDS/RMD #0 contains initialization information. Each of DDS/RMD #1, . . . , and DDS/RMD #n contains DMI or location information of a DMA, and RMD. The location information of the DMA and the RMD may vary whenever a disc is used. Therefore, whenever the location information of the DMA and the RMD varies, corresponding DDS/RMD is updated. DDS/RMD #1 through #n are sequentially recorded side by side in the DDS/RMD area.

In a case where a plurality of DDS/RMD areas exist on a disc, the DDS/RMD areas are preferably, but not necessarily, used one after another. In other words, only after one DDS/RMD area is used up is another DDS/RMD area, subsequent to the one DDS/RMD area, used. Referring to FIGS. 2A and 2B, if the disc is a single-layered recording disc, DDS/RMD areas located in the vicinity of the inner circumference of the disc are used ahead of DDS/RMD areas located in the vicinity of the outer circumference of the disc. Referring to FIGS. 3A through 3D, if the disc is a double-layered recording disc, of those DDS/RMD areas located in the vicinity of the inner circumference of the disc, DDS/RMD areas on the first recording layer L0 are used ahead of DDS/RMD areas on the second recording layer L1. Therefore, the DMD/RMD areas on the disc are used in the order of DDS/RMD area #0, DDS/RMD area #1, DDS/RMD area #2, and DDS/RMD area #3. Accordingly, when the disc is loaded in a disc drive, it is possible to easily identify and then access one of the DDS/RMD areas on the disc where a DDS and RMD have been most recently recorded by determining, in advance, in which order the DDS/RMD areas are to be used.

FIG. 9 is a diagram illustrating the structure of DDS/RMD #0 of FIG. 8. Referring to FIG. 9, DDS/RMD #0 is a data block recorded first in the DDS/RMD area of FIG. 8. DDS/RMD #0 includes DDS #0 and RMD #0. DDS #0 includes location information of an SA/DL zone and location information of the DDS/RMD area.

The location information of the SA/DL zone specifies in which portion of a user data area on a disc the SA/DL has been allotted at the stage of initializing the disc.

The location information of the DDS/RMD area specifies in which portion of the user data area the DDS/RMD area has been allotted at the stage of initializing the disc.

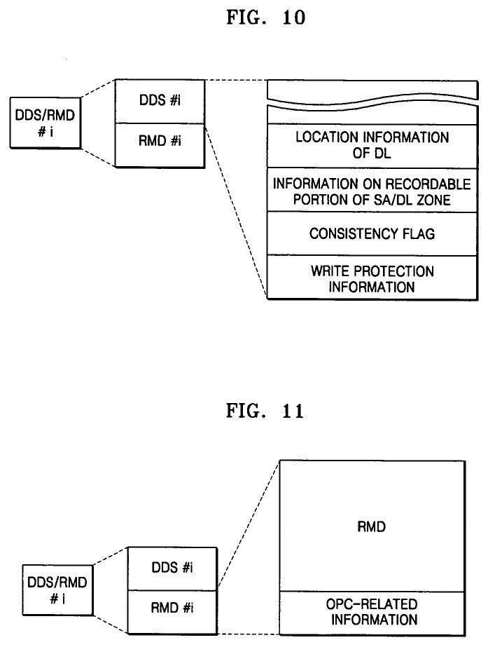

FIG. 10 is a diagram illustrating the structure of DDS/RMD #i of FIG. 8 where i is a whole number. Referring to FIG. 10, DDS/RMD #i includes DDS #i and RMD #i. DDS #i includes location information of a DL, location information of portions of an SA/DL zone that are yet to be used, a consistency flag, and write protection information.

The location information of the DL specifies in which portion of the SA/DL zone the DL is recorded. The consistency flag is a flag used for determining whether a disc has been successfully ejected after a previous recording operation. The write protection information is information used for preventing data from being recorded on the disc.

In particular, the location information of the portions of the SA/DL zone that are yet to be used specifies in which portions of the SA/DL zone data can be recorded next and enables a user to easily identify available portions of the SA/DL zone and to readily record an updated DL or define replacement blocks in the SA/DL zone.

FIG. 11 is a diagram illustrating the structure of RMD #i of DDS/RMD #i of FIG. 8 where i is a whole number. Referring to FIG. 11, RMD #i includes RMD and optimum power control (OPC)-related information.

As described above, the RMD includes recording state information of an R-zone or a bitmap indicating whether data is recorded in each recording block depending on a type of recording mode. The RMD includes Rzones when a sequential recording mode is used and includes bitmaps when a random recording mode is used. The OPC-related information specifies an OPC for recording data on a disc.

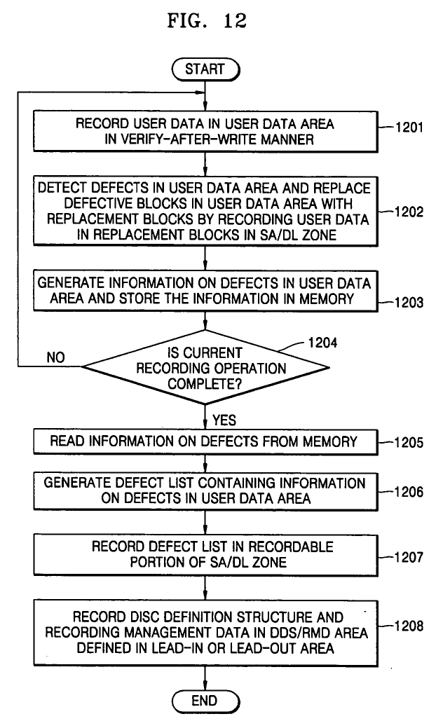

FIG. 12 is a flowchart of a disc management method for recording/reproducing data on/from an optical disc, according to an exemplary embodiment of the present invention. Referring to FIG. 12, in operation 1201, an apparatus records user data in a user data area on a disc in a verify-after-write manner. In operation 1202, defective blocks are detected in the user data area, and replacement blocks respectively replacing the defective blocks are arranged in an SA/DL zone, which occupies part of the user data area. A controller of an apparatus for recording/reproducing data on/from an optical recording medium on an optical recording medium defines, as the replacement blocks, portions of the SA/DL zone that are yet to be used.

In operation 1203, information on the defects, i.e., location information of the defective blocks and location information of the replacement blocks, is generated and then stored in a memory. Operations 1201 through 1203 are repeated until a current recording operation is expected to end.

If the current recording operation is expected to end in operation 1204 after the recording of the user data in the user data area is complete, the controller of the apparatus reads the information on the defects from the memory in operation 1205.

In operation 1206, a DL, including information on at least one defect, is generated. In operation 1207, the DL is recorded in a portion of the SA/DL zone next to a portion of the SA/DL zone that has been most recently allotted for a replacement block.

In operation 1208, a DDS, including a portion of the SA/DL zone where data can be recorded next, and RMD are recorded in a DDS/RMD area, which occupies part of a lead-in area or lead-out area.

Aspects of the present invention can be applied not only to a write-once recording medium but also to a rewritable recording medium.

The method of recording/reproducing data on/from an optical recording medium according to the present invention may be configured as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for configuring the processing methods can be easily construed by programmers skilled in the art to which the present invention pertains.

As described above, according to aspects of the present invention, it is possible to efficiently manage the storage capacity of a disc by effectively managing defects on the disc.

Although a few embodiments of the present invention have been shown and described, it would be appreciated by those skilled in the art that changes may be made in this embodiment without departing from the principles and spirit of the invention, the scope of which is defined in the claims and their equivalents.

1. An optical recording medium, comprising:
a single recording layer, on which a lead-in area, a user data area, and a lead-out area are arranged,
wherein the user data area comprises a defect list (DL) area, in which a DL; including information on defects that have occurred in the user data area, is recorded, and the lead-in area and/or the lead-out area comprises a disc definition structure (DDS)/recording management data (RMD) area, in which a DDS, used to manage the optical recording medium, and an RMD, used to manage a recording state of the optical recording medium, are recorded.

2. An optical recording medium, comprising:
double recording layers, on which a lead-in area, a user data area, a middle area, and a lead-out area are arranged,
wherein the user data area comprises a defect list (DL) area, in which a DL, including information on defects that have occurred in the user data area, is recorded, and the lead-in area, the lead-out area, or the middle area comprises a disc definition structure (DDS)/recording management data (RMD) area, in which a DDS, used to manage the optical recording medium, and an RMD, used to manage a recording state of the optical recording medium, are recorded.

3. An optical recording medium, comprising:
a lead-in area, a user data area, and a lead-out area arranged on the optical recording medium,
wherein the user data area comprises a spare area (SA)/defect list (DL) zone, in which replacement blocks respectively replacing blocks in the user data area where defects occur are arranged, and a DL comprising information on the defects in the user data area, is recorded.

4. The optical recording medium of claim 3, wherein portions of the SA/DL zone where each of the replacement blocks is respectively arranged are determined when there is a need to arrange each of the replacement blocks in the SA/DL zone, rather than in advance.

5. The optical recording medium of claim 3, wherein portions of the SA/DL zone where the DL is recorded are determined when there is a need to record the DL in the SA/DL zone, rather than in advance.

6. The optical recording medium of claim 3, wherein a beginning or ending portion of the user data area is defined as the SA/DL zone.

7. The optical recording medium of claim 3, wherein the lead-in area and/or the lead-out area comprises a disc definition structure (DDS)/recording management data (RMD) area, in which a DDS/RMD block is recorded, and the DDS/RMD block comprises a DDS, used to manage the optical recording medium, and RMD, used to manage a recording state of the optical recording medium.

8. The optical recording medium of claim 7, wherein the DDS comprises location information of a next recordable portion of the SA/DL zone.

9. The optical recording medium of claim 7, wherein the DDS/RMD block is updated based on a recording state of the optical recording medium, and updated DDS/RMD blocks are sequentially located in the DDS/RMD area.

10. The optical recording medium of claim 7, wherein a first DDS recorded in the DDS/RMD area comprises location information of the SA/DL zone in the user data area and location information of the DDS/RMD area in the lead-in area and/or lead-out area.

11. An apparatus recording/reproducing data on/from an optical recording medium, comprising:
a reading/writing unit, which writes the data on or reads the data from a single-layered recording medium, on which a lead-in area, a user data area, and a lead-out area are arranged; and
a control unit, which controls the reading/writing unit to write a defect list (DL), comprising information on defects occurring in the user data area, in a DL zone arranged in the user data area, and to write a disc definition structure (DDS), used to manage the single-layered recording medium, and recording management data (RMD), used to manage a recording state of the single-layered recording medium, in a disc definition structure (DDS)/recording management data (RMD) area arranged in the lead-in area and/or in the lead-out area.

12. An apparatus recording/reproducing data on/from an optical recording medium, comprising:
a reading/writing unit, which writes the data on or reads the data from a double-layered recording medium, on which a lead-in area, a user data area, a middle area, and a lead-out area are arranged; and
a control unit, which controls the reading/writing unit to write a defect list (DL), comprising information on defects that have occurred in the user data area, in a DL zone arranged in the user data area, and to write a disc definition structure (DDS), used to manage the double-layered recording medium, and recording management data (RMD), used to manage a recording state of the double-layered recording medium, in a disc definition structure (DDS)/recording management data (RMD) area arranged in at least one of the lead-in area, in the middle area or in the lead-out area.

13. An apparatus recording/reproducing data on/from an optical recording medium, comprising:
a reading/writing unit, which writes the data on or reads the data from an optical recording medium, on which a lead-in area, a user data area, a middle area, and a lead-out area are arranged; and
a control unit, which controls the reading/writing unit to write replacement blocks respectively replacing blocks in the user data area where defects occur in a spare area (SA)/defect list (DL) zone arranged in the user data area and records a DL, comprising information on the defects in the user data area, in the SA/DL zone.

14. The apparatus of claim 13, wherein the control unit controls the reading/writing unit to sequentially write the replacement blocks in recordable portions of the SA/DL zone.

15. The apparatus of claim 13, wherein the control unit controls the reading/writing unit to write the DL in a recordable portion of the SA/DL zone.

16. The apparatus of claim 13, wherein the control unit allocates the SA/DL zone at a beginning or ending portion of the user data area.

17. The apparatus of claim 13, wherein the control unit controls the reading/writing unit to write a disc definition structure (DDS)/recording management data (RMD) block, which comprises a DDS used to manage the optical recording medium and RMD used to manage a recording state of the optical recording medium in a DDS/RMD area arranged in the lead-in area and/or lead-out area.

18. The apparatus of claim 17, wherein the control unit further controls the reading/writing unit to write the DDS, comprising location information of a next recordable portion of the SA/DL zone, in the DDS/RMD area.

19. The apparatus of claim 17, wherein the control unit further controls the reading/writing unit to write an updated DDS/RMD block in the DDS/RMD area.

20. The apparatus of claim 17, wherein the control unit controls the reading/writing unit so that the reading/writing unit records a DDS/RMD block, which comprises the DDS, used manage the optical recording medium, and RMD, used to manage a recording state of the optical recording medium, in a beginning portion of the DDS/RMD area.

21. A method of recording data on an optical recording medium on which a lead-in area, a user data area, and a lead-out area are arranged, the method comprising:
recording a defect list (DL), which includes information on defects that have occurred in the user data area, in a DL zone arranged in the user data area; and
recording a disc definition structure (DDS), which is used to manage the single-layered recording medium, and recording management data (RMD), which is used to manage a recording state of the single-layered recording medium, in a DDS/RMD area arranged in the lead-in area and/or lead-out area.

22. A method of recording/reproducing data on/from an optical recording medium on which a lead-in area, a user data area, a middle area, and a lead-out area are arranged, the method comprising:
recording a defect list (DL), including information on defects occurring in the user data area, in a DL zone arranged in the user data area; and
recording a disc definition structure (DDS), used to manage the double-layered recording medium, and recording management data (RMD), used to manage a recording state of the double-layered recording medium, in a DDS/RMD area arranged in at least one of the lead-in area, middle area, or lead-out area.

23. A method of recording data on an optical recording medium, on which a lead-in area, a user data area, a middle area, and a lead-out area are arranged, the method comprising:
defining replacement blocks in a spare area (SA)/defect list (DL) zone arranged in the user data area and recording a DL, which includes information on defects occurring in the user data area, in the SA/DL zone, the replacement blocks respectively replacing blocks in the user data area where the defects occur.

24. The method of claim 23, wherein the defining of the replacement blocks in the SA/DL zone, comprises arranging the replacement blocks sequentially in recordable portions of the SA/DL zone.

25. The method of claim 23, wherein the recording of the DL comprises recording the DL in a recordable portion of the SA/DL zone.

26. The method of claim 23, further comprising:
allocating the SA/DL zone at a beginning or ending portion of the user data area.

27. The method of claim 23, further comprising:
recording a disc definition structure (DDS)/recording management data (RMD) block, which comprises a DDS used to manage the optical recording medium and RMD used to manage a recording state of the optical recording medium, in a DDS/RMD area arranged in the lead-in area and/or lead-out area.

28. The method of claim 27, further comprising:
forming the DDS to include location information of a next recordable portion of the SA/DL zone.

29. The method of claim 27, further comprising:
recording sequentially an updated DDS/RMD block in the DDS/RMD area.

30. The method of claim 27, further comprising:
recording the DDS/RMD block, which comprises the DDS used to manage the optical recording medium and the RMD used to manage the recording state of the optical recording medium in a beginning portion of the DDS/RMD area.

31. A method of reproducing data from an optical recording medium on which a lead-in area, a user data area, and a lead-out area are arranged, the method comprising:
reading a defect list (DL), which includes information on defects that have occurred in the user data area of a single-layered recording optical recording medium, from a DL zone arranged in the user data area; and
reading a disc definition structure (DDS), which is used to manage the single-layered recording optical recording medium, and recording management data (RMD), which is used to manage a recording state of the single-layered recording optical recording medium, from a DDS/RMD area arranged in the lead-in area and/or lead-out area.

32. A method of reproducing data from an optical recording medium on which a lead-in area, a user data area, a middle area, and a lead-out area are arranged, the method comprising:
reading a defect list (DL), which includes information on defects occurring in the user data area of a double-layered recording optical recording medium, from a DL zone arranged in the user data area; and
reading a disc definition structure (DDS), which is used to manage the single-layered recording optical recording medium, and recording management data (RMD), which is used to manage a recording state of the single-layered recording optical recording medium, from a DDS/RMD area arranged in at least one of the lead-in area, middle area, or lead-out area.

33. A method of reproducing data from an optical recording medium, on which a lead-in area, a user data area, a lead-out area are arranged, the method comprising:
reading data from replacement blocks in a spare area (SA)/defect list (DL) zone on the optical recording medium and reading a DL, which includes information on defects occurring in the user data area, from the SA/DL zone, the replacement blocks respectively replacing blocks in the user data area where the defects have occurred.

34. The method of claim 33, further comprising:
reading a disc definition structure (DDS)/recording management data (RMD) block, which comprises a DDS used to manage the optical recording medium and RMD used to manage a recording state of the optical recording medium, from a DDS/RMD area arranged in the lead-in area and/or lead-out area.

35. The method of claim 34, further comprising:
obtaining location information of a next recordable portion of the SA/DL zone from the DDS.

36. The method of claim 34, further comprising:
reading most recently updated DDS/RMD from a last DDS/RMD block of a plurality of DDS/RMD blocks in the DDS/RMD area, the DDS/RMD being updated whenever the recording state of the optical recording medium changes.

37. The method of claim 34, further comprising:
reading location information of the SA/DL zone in the user data area and location information of the DDS/RMD area in the lead-in area and/or lead-out area from a first DDS/RMD block of the plurality of DDS/RMD blocks in the DDS/RMD area.

38. A computer-readable recording medium on which a program for executing a method of recording data on an optical recording medium, on which a lead-in area, a user data area, a lead-out area are arranged, is recorded, the method comprising:
recording a defect list (DL), which includes information on defects occurring in the user data area, in a DL zone arranged in the user data area; and
recording a disc definition structure (DDS), which is used to manage the single-layered recording medium, and recording management data (RMD), which is used to manage a recording state of the optical recording medium, in a DDS/RMD area arranged in the lead-in area and/or lead-out area.

39. A computer-readable recording medium on which a program for executing a method of reproducing data from an optical recording medium, on which a lead-in area, a user data area, a lead-out area are arranged, is recorded, the method comprising:
reading a defect list (DL), which includes information on defects occurring in a user data area of a single-layered recording optical recording medium, from a DL zone arranged in the user data area; and
reading a disc definition structure (DDS), which is used to manage the single-layered recording optical recording medium, and recording management data (RMD), which is used to manage a recording state of the single-layered recording optical recording medium, from a DDS/RMD area arranged in the lead-in area and/or lead-out area.

40. An optical recording medium for use with a recording and/or reproducing apparatus, comprising:
a data area which the recording and/or reproducing apparatus records data in and/or reads data from,
a defect list area which stores location information of defects occurring in the user data area and replacement data corresponding to the defects, wherein the defect list area is disposed in a portion of the data area according to control of the recording and/or reproducing apparatus.

41. The optical recording medium of claim 40, wherein the recording and/or reproducing apparatus records the data in the data area in a first direction and records the location information and the replacement information in a second direction opposite the first direction in the defect list area.

42. The optical recording medium of claim 40, wherein the defect list area comprises a first portion at a beginning of the data area and a second portion at an end of the data area.

43. The optical recording medium of claim 40, further comprising:
a disc definition structure (DDS)/recording management data (RMD) area, which includes a DDS which stores management information of the optical recording medium, and RMD which manages a recording state of the optical recording medium are recorded by the recording and/or reproducing apparatus in at least one of a lead-in and/or lead-out area of the optical recording medium.

44. The optical recording medium of claim 43, wherein the defect list area comprises a first portion of the data area and a second portion, nonadjacent the first portion, of the data area.

45. A method of managing data on an optical recording medium on which a lead-in area, a data area, and a lead-out area are arranged, the method comprising:
collocating in a spare/defect zone a spare area storing replacement blocks corresponding to defective blocks of the data area and defect list information storing location information of the replacement blocks and the defective blocks in a portion of the data area.

46. The method of claim 45, wherein a recording direction of the data area and the spare/defect zone are opposite each other.

47. The method of claim 45, wherein the spare/defect zone is disposed at an end portion of the data area.

48. The method of claim 45, further comprising:
recording a disc definition structure (DDS)/recording management data (RMD) area, which includes a DDS storing management information of the optical recording medium, and RMD managing a recording state of the optical recording medium in at least one of the lead-in and/or the lead-out area of the optical recording medium.

49. The method of claim 45, further comprising:
updating the defect list information whenever one replacement block is created for one defective block in the data area.

50. The method of claim 45, further comprising:
recording a disc definition structure (DDS)/recording management data (RMD) area, which includes a DDS storing management information of the optical recording medium, and RMD managing a recording state of the optical recording medium in at least one of the lead-in, the lead-out area or a middle area of the optical recording medium when the optical recording medium comprises at least two recording layers.
